(19) United States
(12) Patent Application Publication
(10) Pub. No.: US 2002/0063884 A1
(43) Pub. Date: May 30, 2002

(54) Priority printing

(75) Inventors: Kulvir Singh Bhogal, Fort Worth, TX (US); Bali Baweja, Austin, TX (US); Nizam Ishmael, Austin, TX (US); Mandeep Sidhu, Austin, TX (US)

Correspondence Address: Duke W. Yee, Carstens, Yee & Cahoon, LLP, P.O. Box 802334, Dallas, TX, 75380, US

(73) Assignee: IBM Corporation

(21) Appl. No.: 09/725,350

(22) Filed: Nov. 29, 2000

(51) Int. Cl. G06F 15/00; B41B 1/00

(52) U.S. Cl. 358/1.15

(57) ABSTRACT

A method for managing printing priorities in a computer network environment is provided. The method includes priorities for network print jobs being set by a network administrator and/or network users. The priority of a new print job entering the print queue is compared to the priority of other jobs already in the queue. The new job is delayed until any higher priority jobs have finished printing. If the new print job has the highest priority in the print queue and has a higher priority than the job currently printing, the current job is suspended until the new job prints in full. The suspended job is then resumed. The priority settings can be changed by the network administrator and/or the network users, according to changing circumstances.

### BACKGROUND OF THE INVENTION

1. Technical Field

The present invention relates to printing in a network environment. More specifically, the invention relates to controlling the priority of print jobs.

2. Description of Related Art

In a computer network environment, network users must often share the same printing resources. If several network users are attempting to use the same printer at roughly the same time, significant delays will occur in the printing of high priority print jobs. In fact, a single large print job can delay several smaller print jobs. This essentially allows one person to disrupt the work of several people, leading to considerable productivity problems for the entire network. If several people are attempting to print large print jobs, the congestion can become even more severe. However, the problem is not limited to large print jobs. If too many print jobs enter the printing queue, it will result in delays and productivity loss, even if the print jobs individually are small.

As with any other scarce resource, printing resources in a computer network must be allocated according to specific rules which determine priority. Considerations giving rise to priority among competing print jobs can include, for example, the size of the print jobs, the relative importance of particular projects, the status of network users within an organization, as well as any other factor that may determine why one print job should be printed before competing print jobs.

However, print priorities must also be flexible and should be able to adjust to changing network printer traffic. As computer networks become larger and more complicated, more focus should be given to the ability to manage and adjust the resources of the network as circumstances change, something that cannot be done with automatic, bright line priority rules. The work performed by individual network users often changes in priority. Therefore users may wish to change their printing priorities accordingly and should be able to request a desired level of priority for their submitted print jobs. However, there should also be some central control on the part of a network administrator, who would be in a better position to evaluate the total demand placed on the network's printing resources.

The prior art does not provide much power to network administrators and users to control the priority of how and when print jobs print, and the ability to change printing priorities as circumstances rapidly evolve. Therefore, a method that allows network administrators and users to control the priority of print jobs, while providing the flexibility to adjust to changing work priorities and network demands, would be desirable.

### SUMMARY OF THE INVENTION

The present invention provides a method for managing printing priorities in a computer network environment. The method includes setting the priorities of network print jobs. These priority settings can be determined by a network administrator and/or network users. The priority of a new print job entering the print queue is compared to the priority of other jobs already in the queue. If there are print jobs in the queue with higher priority than the new print job, the new job is delayed until the higher priority jobs have finished printing.

In one embodiment, if the new print job has the highest priority in the queue, its priority is compared to any job currently printing. If the new print job has a higher priority than the job currently printing, the current job is suspended until the new job prints in full. The suspended job is then resumed.

In another embodiment, the priority settings can be changed by the network administrator and/or the network users, according to changing circumstances.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a distributed data processing system in which the present invention may be implemented;

FIG. 2 depicts a block diagram of a data processing system which may be implemented as a server, in accordance with the present invention;

FIG. 3 depicts a block diagram of a data processing system in which the present invention may be implemented; and

FIG. 4 depicts a flowchart illustrating a method for setting and managing network printing priorities in accordance with the present invention.

### DETAILED DESCRIPTION OF THE PREFERRED EMBODIMENT

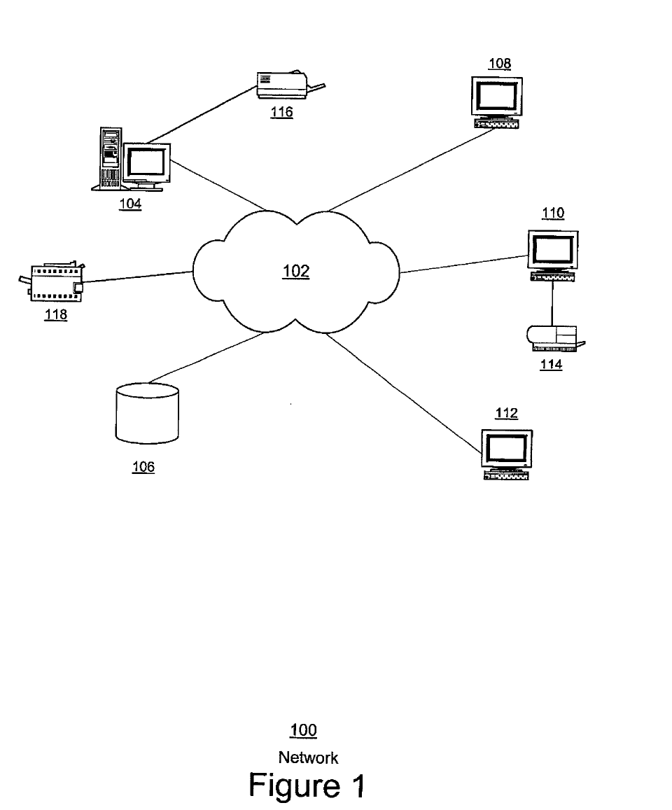

With reference now to the figures, and in particular with reference to FIG. 1, a pictorial representation of a distributed data processing system is depicted in which the present invention may be implemented.

Distributed data processing system 100 is a network of computers in which the present invention may be implemented. Distributed data processing system 100 contains network 102, which is the medium used to provide communications links between various devices and computers connected within distributed data processing system 100. Network 102 may include permanent connections, such as wire or fiber optic cables, or temporary connections made through telephone connections. In the depicted example, server 104 is connected to network 102, along with storage unit 106. In addition, clients 108, 110 and 112 are also connected to network 102. These clients, 108, 110 and 112, may be, for example, personal computers or network computers.

For purposes of this application, a network computer is any computer coupled to a network that receives a program or other application from another computer coupled to the network. In the depicted example, server 104 provides data, such as boot files, operating system images and applications, to clients 108-112. Clients 108, 110 and 112 are clients to server 104. Distributed data processing system 100 may include additional servers, clients, and other devices not shown. Distributed data processing system 100 also includes printers 114, 116 and 118. A client, such as client 110, may print directly to printer 114. Clients such as client 108 and client 112 do not have directly attached printers. These clients may print to printer 116, which is attached to server 104, or to printer 118, which is a network printer that does not require connection to a computer for printing documents. Client 110, alternatively, may print to printer 116 or printer 118, depending on the printer type and the document requirements.

In the depicted example, distributed data processing system 100 is the Internet, with network 102 representing a worldwide collection of networks and gateways that use the TCP/IP suite of protocols to communicate with one another. At the heart of the Internet is a backbone of high-speed data communication lines between major nodes or host computers consisting of thousands of commercial, government, education, and other computer systems that route data and messages. of course, distributed data processing system 100 also may be implemented as a number of different types of networks such as, for example, an intranet or a local area network.

FIG. 1 is intended as an example and not as an architectural limitation for the processes of the present invention.

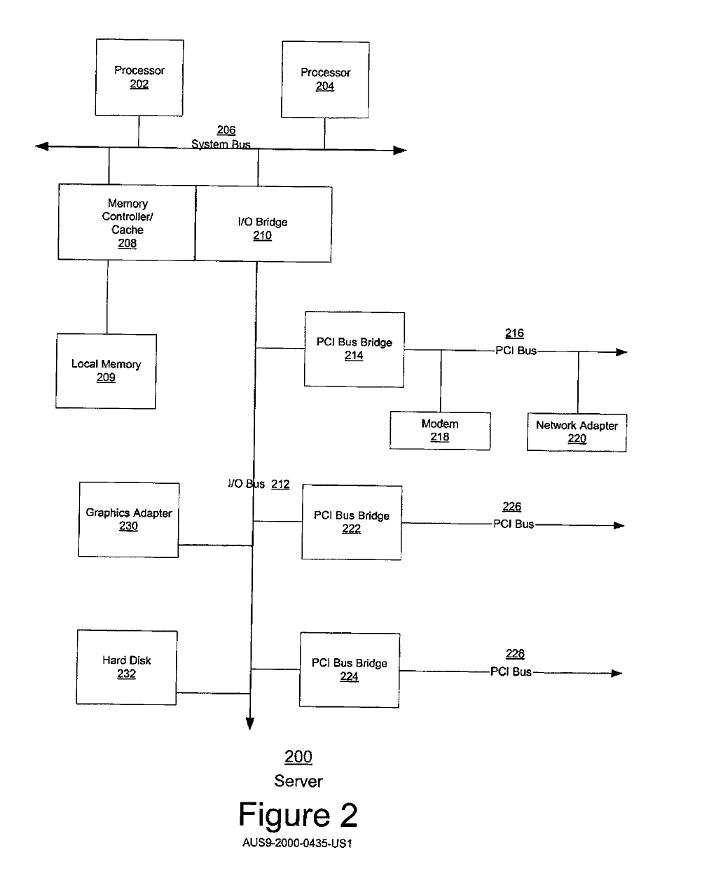

Referring to FIG. 2, a block diagram of a data processing system which may be implemented as a server, such as server 104 in FIG. 1, is depicted in accordance with the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems 218-220 may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, server 200 allows connections to multiple network computers. A memory mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RS/6000, a product of International Business Machines Corporation in Armonk, N.Y., running the Advanced Interactive Executive (AIX) operating system.

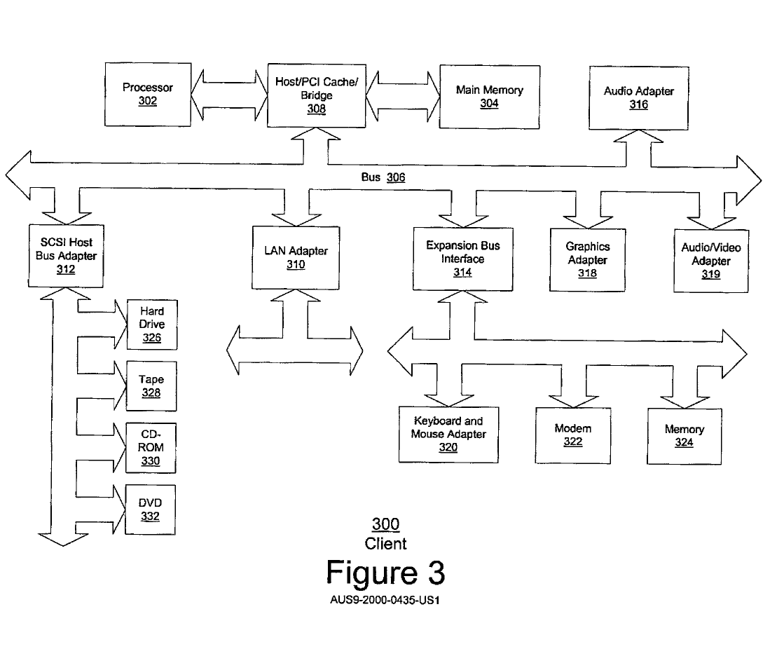

With reference now to FIG. 3, a block diagram of a data processing system in which the present invention may be implemented is illustrated. Data processing system 300 is an example of a client computer. Data processing system 300 employs a peripheral component interconnect (PCI) local bus architecture. Although the depicted example employs a PCI bus, other bus architectures, such as Micro Channel and ISA, may be used. Processor 302 and main memory 304 are connected to PCI local bus 306 through PCI bridge 308. PCI bridge 308 may also include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter (A/V) 319 are connected to PCI local bus 306 by add-in boards inserted into expansion slots. Expansion bus interface 314 provides a connection for a keyboard and mouse adapter 320, modem 322, and additional memory 324. In the depicted example, SCSI host bus adapter 312 provides a connection for hard disk drive 326, tape drive 328, CD-ROM drive 330, and digital video disc read only memory drive (DVD-ROM) 332. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as AIX, which is available from International Business Machines Corporation. “AIX” is a trademark of International Business Machines Corporation. An object oriented programming system, such as Java, may run in conjunction with the operating system, providing calls to the operating system from Java programs or applications executing on data processing system 300. Instructions for the operating system, the object-oriented operating system, and applications or programs are located on a storage device, such as hard disk drive 326, and may be loaded into main memory 304 for execution by processor 302.

Those of ordinary skill in the art will appreciate that the hardware in FIG. 3 may vary depending on the implementation. For example, other peripheral devices, such as optical disk drives and the like, may be used in addition to or in place of the hardware depicted in FIG. 3. The depicted example is not meant to imply architectural limitations with respect to the present invention. For example, the processes of the present invention may be applied to multiprocessor data processing systems.

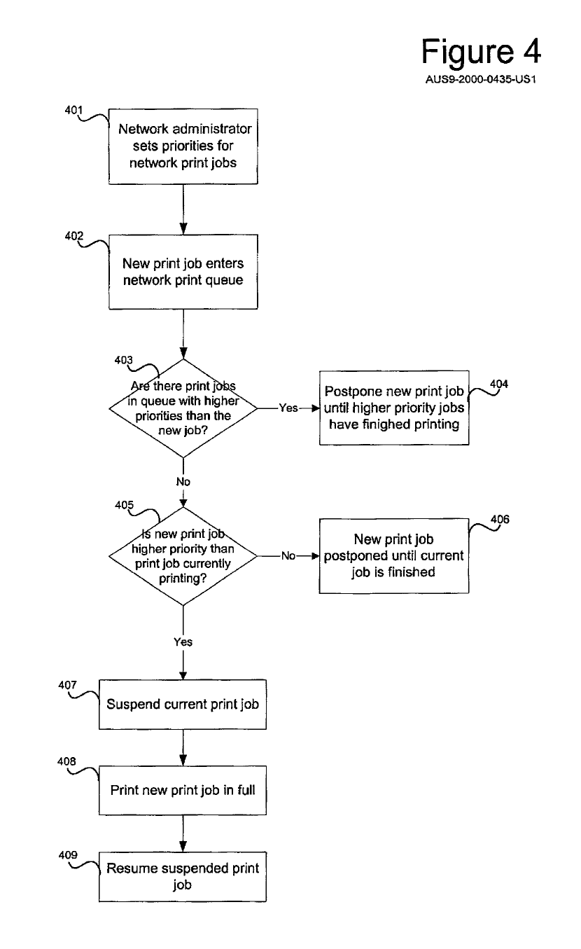

In reference to FIG. 4, a flowchart illustrating a method for setting and managing network printing priorities is depicted in accordance with the present invention. The process begins by setting priorities for network print jobs (step 401). In the example of FIG. 4, the priorities are set by a network administrator. The criteria used for establishing print priorities can include, for example, the size of the print jobs, the status of network users within an organization, and the importance of the project associated with a print job. In addition, the priorities do not have to be based on only one type of criteria. A combination of criteria can be used in setting print priorities within the network.

In one embodiment of the present invention, the print priorities can be established in whole or in part by the network users themselves. A network user, upon submitting a print job, can specify the degree of importance of the print job. For example, the user could specify 1 for high priority or 5 for low priority. A priority of 1 would be used if the user wants the job to print as soon as possible. A priority of 5 would be used if the user is in no immediate need to print, but would still like the job to be printed. An example of a 5 priority would be printing a large manual that the user does not need right away. These priorities can be determined entirely by the users themselves, or a network administrator can review the priorities requested by users and make adjustments according to overall network traffic.

Another embodiment would allow the network administrator to set print priorities and then allow network users to override those priorities according to changing circumstances. This provides flexibility in adjusting network printing priorities without having to constantly go through a central administrator.

The priorities of print jobs can be changed after a print job has entered the printing queue, whether the priorities are changed by the network administrator or users. This allows priorities to adjust to changing circumstances, which is necessary when dealing with large computer networks. The prior art does not allow for this type of flexibility in adjusting print priorities. Prior art approaches rely on fixed, bright line rules, which function automatically and do not allot much power to network administrators or users for determining and changing print priorities, as circumstances dictate.

Once printing priorities have been established, a network user sends a print job to the printing queue (step 402). A print queue is disk space in a computer system that holds data output designated for a printer, until the printer can receive it. Print queues are necessary because printing generally occurs at much slower speeds than most other computer applications. When an application is requested to print a document, it immediately generates the output on disk. The output is then fed to a print spooler, which manages printing in the computer. Spooling (Simultaneous Peripheral Operations OnLine) is used to buffer data when low speed operations overlap with normal processes. A print spooler feeds printing images to a printer at the slower printing speed. The print image is a text or graphics document that has been prepared for a printer. Format codes for the required printer are imbedded in the document. The printing is then done in the background while higher speed applications are performed in the foreground.

The priority of the new print job is compared to the priority of other print jobs that might already be in the queue (step 403). If the new print job does not have the highest priority in the queue, it is postponed until higher priority print jobs have finished printing (step 404). If the new print job does have the highest priority in the queue, the next step is to determine if it has a higher priority than the job currently printing (step 405).

If the current print job has a higher priority, the new print job is postponed until the current job is complete (step 406). If the new print job has a higher priority, the current job is suspended (step 407), and the new job prints in full (step 408). After the new print job is complete, the suspended print job is resumed (step 409), assuming that another higher priority job has not entered the print queue. Different colored sheets can be used to separate different print jobs and portions of print jobs.

It is important to note that the order of print jobs in the printing queue can change not only in response to new print jobs entering the queue, but also in response to changes in the priority settings made by the network administrator and/or users.

As new print jobs enter the queue, the relative priority and estimated completion time for a given print job is likely to change several times. It is important for a network user to be aware of when his or her print job will be finished. Therefore, the present invention provides a graphical user interface (GUI) for informing the network user of the estimated time remaining until the print job is complete. If the print job has already started printing, the GUI will inform the user of the estimated time remaining until the print job is finished. It is important to note that this estimated time remaining will be dynamic and will update itself based upon network printer traffic and jobs that enter the printing queue.

In the case when a print job has not yet begun to print, the GUI will give the user an estimate of how long it will be before the job is finished. Based on this information, the user can decide whether or not to proceed. The GUI can send prompts at set time intervals, updating the user as to the estimated time to completion. The user can choose to keep the print job in the queue or cancel the job.

As new print jobs enter the queue, or as priority rules are changed by the administrator and/or users, the priority of a particular print job might change several times. This presents the risk of low priority print jobs being perpetually sent to the back of the queue or interrupted by higher priority jobs. To avoid this problem, the present invention allows a maximum time limit to be set for delaying any particular print job. For example, a limit of 12 hours might be set as the maximum amount of time a print job can be delayed before printing in full.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for managing printing priorities in a computer network, comprising:
entering priority settings for network print jobs;
receiving a new print job and an associated priority setting into a network printing queue;
comparing the priority setting of the new print job to a priority of other print jobs in the network printing queue; and
allowing the new print job to begin printing without delay if it has the highest priority in the network printing queue.

2. The method according to claim 1, wherein the priority settings are entered by a network administrator.

3. The method according to claim 1, wherein the priority settings are entered by a network user.

4. The method according to claim 1, further comprising postponing the new print job until higher priority print jobs in the network printing queue have finished printing.

5. The method according to claim 1, wherein the step allowing the new print job to begin without delay further comprises:
suspending a print job that is currently printing if the new print job has a higher priority;
printing the new print job in full; and
resuming the suspended print job.

6. The method according to claim 5, further comprising using different colored sheets to separate different print jobs.

7. The method according to claim 1, wherein the priority settings may be changed, according to changing circumstances.

8. The method according to claim 7, wherein changes to the priority settings are entered by a network administrator.

9. The method according to claim 7, wherein changes to the priority setting are entered by a network user.

10. The method according to claim 1, further comprising providing a graphical user interface for displaying the estimated time for completing a print job.

11. The method according to claim 10, further comprising sending prompts to users at set time intervals updating the estimated time for completing a print job.

12. The method according to claim 1, further comprising receiving a maximum time limit for postponing a print job, regardless of its priority.

13. A method for managing printing priorities in a computer network, comprising:
receiving a priority for a network print job; and
sending the network print job and the priority to a network printing queue.

14. The method according to claim 13, wherein the priority for the network print job is set by a network user.

15. The method according to claim 13, further comprising:
receiving changes to the priority settings, according to changing circumstances; and
sending the changes to the priority settings to the print queue.

16. The method according to claim 15, wherein the changes to the priority settings are made by a user.

17. The method according to claim 13, further comprising:
receiving the estimated time for completing a print job; and
displaying the estimated time for completing a print job to a user.

18. The method according to claim 17, further comprising:
receiving a maximum time limit for postponing a print job, regardless of its priority; and
sending the maximum time limit to the printing queue.

19. The method according to claim 17, wherein the step of displaying the estimated time for completing a print job is by means of a graphical user interface.

20. The method according to claim 19, further comprising receiving prompts at set time intervals updating the estimated time for completing a print job.

21. A computer program product in a computer readable medium for use in a data processing system for managing printing priorities in a computer network, the computer program product comprising:
instructions for entering priority settings for network print jobs;
instructions for receiving a new print job and an associated priority setting into the network printing queue;
instructions for comparing the priority of the new print job to the priority of other print jobs in the network printing queue; and
instructions for allowing the new print job to begin printing without delay if it has the highest priority in the network printing queue.

22. The computer program product according to claim 21, wherein the priority settings are entered by a network administrator.

23. The computer program product according to claim 21, wherein the priority settings are entered by a network user.

24. The computer program product according to claim 21, further comprising instructions for postponing the new print job until higher priority print jobs in the network printing queue have finished printing.

25. The computer program product according to claim 21, further comprising instructions for receiving changes to the priority settings, according to changing circumstances.

26. A data processing system for managing printing priority in computer networks, comprising:
means for entering priority settings for network print jobs;
means for receiving a new print job and an associated priority setting into the network printing queue;
means for comparing the priority of the new print job to the priority of other print jobs in the network printing queue; and
means for allowing the new print job to begin printing without delay if it has the highest priority in the network printing queue.

27. The data processing system according to claim 26, wherein the priority settings are entered by a network administrator.

28. The data processing system according to claim 26, wherein the priority settings are entered by a network user.

29. The data processing system according to claim 26, further comprising means for postponing the new print job until higher priority print jobs in the network printing queue have finished printing.

30. The data processing system according to claim 26, further comprising means for receiving changes to the priority settings, according to changing circumstances.
